(19) United States
(12) Patent Application Publication
(10) Pub. No.: US 2009/0067503 A1
(43) Pub. Date: Mar. 12, 2009

(54) METHOD AND APPARATUS FOR VIDEO DATA ENCODING AND DECODING

(75) Inventors: Se-Yoon Jeong, Daejeon-city (KR); Jeong-Il Seo, Daejeon-city (KR); Kyu-Heon Kim, Daejeon-city (KR); Kyeongok Kang, Daejeon-city (KR); Jin-Woo Hong, Daejeon-city (KR); Yung-Lyul Lee, Seoul (KR); Dae-Yeon Kim, Seoul (KR); Dong-Gyun Kim, Seoul (KR); Seoung-Jun Oh, Gyeonggi-do (KR); Dong-Gyu Sim, Seoul (KR); Chang-Beom Ahn, Seoul (KR)

Correspondence Address: LADAS & PARRY LLP, 224 SOUTH MICHIGAN AVENUE, SUITE 1600, CHICAGO, IL, 60604, US

(73) Assignees: ELECTRONICS AND TELECOMMUNICATIONS RESEARCH INSTITUTE, Daejeon-city (KR); KWANGWOON UNIVERSITY RESEARCH INSTITUTE FOR INDUSTRY COOPERATION, Seoul (KR)

(21) Appl. No.: 12/160,154

(22) PCT Filed: Jan. 5, 2007
(86) PCT No.: PCT/KR07/00082

§ 371 Date: Jul. 7, 2008

(30) Foreign Application Priority Data
Jan. 7, 2006 (KR) 10-2006-0002042
Jan. 5, 2007 (KR) 10-2007-0001386

(51) Int. Cl. H04N 7/30; H04N 7/26

(52) U.S. Cl. 375/240.16; 375/240.12; 375/E07.211

(57) ABSTRACT

Video data encoding and decoding methods and apparatuses are provided. In the video data encoding and decoding methods, codes books are provided to an encoder and a decoder. In the encoder, an index corresponding to a vector that is most similar to a current vector of an input moving picture among the vectors of the code book is encoded. In the decoder, the index is decoded. Accordingly, it is possible to increase compression ratio and reduce calculation complexity.

### TECHNICAL FIELD

The present invention relates to video data encoding and decoding methods and apparatuses, and more particularly, to video data encoding and decoding methods and apparatuses capable of increasing a compression ratio and reducing calculation complexity in a decoder by encoding only an index corresponding to a vector that is most similar to a residual transform coefficient among vectors of a code book in an operation of encoding the residual transform coefficient obtained by performing discrete cosine transformation (DCT) and quantization.

### BACKGROUND ART

In H.264/MPEG-4 advanced video coding (AVC) that is one of existing video signal compression standards, multiple reference motion compensation, loop filtering, variable block size motion compensation, Context Adaptive Binary Arithmetic Coding (CABAC), and other entropy coding has been used in order to increase a compression ratio.

According to the H.264 standard, in order to reorder residual transform coefficients obtained by performing discrete cosine transformation (DCT) and quantization on a residual block that is a difference between a current block and a predicted block in a shortest one-dimensional (1-D) array, zigzag scan and a Run-Level encoding are carried out, and output symbols are finally encoded by an entropy encoder.

In general, with respect to a probability that a non-zero residual transform coefficient exists at a position in a 4×4 block, the highest probability appears in the left upper region (DC), and a distribution of probabilities has symmetry with respect to horizontal and vertical directions. In order to use such characteristics, the zigzag scan is carried out from the DC residual transform coefficient, so that the residual transform coefficients are reordered into a 1-D array. Since the reordered residual transform coefficients include a large number of zeros, “0”, the residual transform coefficients can be represented in a simpler form by using the Run-Level encoding procedure. Here, “Run” denotes the number of zeros, “0”, preceding a non-zero residual transform coefficient, and “Level” denotes the size of a non-zero residual transform coefficient. Subsequently, each Run and Level pair obtained by the Run-Level encoding procedure is encoded into independent symbols.

In conventional video encoding and decoding technology, when there is a strong correlation between pixels in a prediction difference signal block, a small number of bits are needed for the encoding of the prediction difference signal. On the contrary, when there is a weak correlation between the pixels in the prediction difference signal block, a large number of bits are needed for the encoding of the prediction difference signal. In addition, inverse quantization and inverse DCT need to be performed in a decoder, and therefore calculation complexity in the decoder may be increased.

### DETAILED DESCRIPTION OF THE INVENTION

### Technical Problem

The present invention provides video data encoding method and an apparatus for encoding a residual transform coefficient obtained by performing discrete cosine transformation (DCT) or other types of transformation and quantization, capable of increasing compression ratio by encoding only an index corresponding to a vector that is most similar to the residual transform coefficient among N×1 vectors corresponding to indices of a code book of residual transform coefficients that are obtained by training of other pictures.

The present invention also provides video data decoding method and an apparatus capable of reducing calculation complexity by storing in advance a table of residual coefficients obtained by performing inverse quantization and inverse DCT and indices matching the residual coefficients and looking up a residual coefficient corresponding to a received index from the table.

The other objects and advantages of the present invention can be understood and more clarified through embodiments disclosed in the detailed description of the invention. In addition, it can be understood that the objects and advantages of the present invention will be implemented by constructions and features disclosed in claims and a combination thereof.

### Technical Solution

According to an aspect of the present invention, there is provided a video data encoding method comprising: generating a vector corresponding to a residual transform coefficient obtained by transforming and quantizing a residual block that is a difference between a current block and a predicted block; searching for a reference vector that is most similar to the vector among reference vectors corresponding to residual transform coefficient blocks of a sampled picture; and performing entropy encoding on an index matching the searched reference vector.

According to another aspect of the present invention, there is provided a video data encoding method comprising: generating a residual transform coefficient by transforming and quantizing a residual block that is a difference between a current block and a predicted block; and selecting a path among paths where entropy encoding is performed on the residual transform coefficient.

According to another aspect of the present invention, there is provided a video data encoding method comprising: generating vectors corresponding to residual coefficients; and clustering the vectors based on spatial nearness of the vectors.

According to another aspect of the present invention, there is provided a video data decoding method comprising: receiving vectors that correspond to residual transform coefficients obtained by transforming and quantizing a residual block that is a difference between a current block and a predicted block, wherein the vectors are allocated with indices; and performing entropy decoding on the vectors and storing the vectors with indices matching the vectors.

According to another aspect of the present invention, there is provided a video data decoding method comprising: extracting from a bitstream including index information an index matching a vector corresponding to a residual transform coefficient obtained by transforming and quantizing a residual block that is a difference between a current block and a predicted block; and reconstructing the residual block based on the extracted index.

According to another aspect of the present invention, there is provided a video data decoding method comprising: extracting path information from a bitstream, wherein the path information includes information on a first path where a residual transform coefficient obtained by transforming and quantizing a residual block that is a difference between a current block and a predicted block is decoded and a second path where an index corresponding to the residual transform coefficient is decoded; and reconstructing the residual block that is the difference between the current block and the predicted block by performing entropy decoding, inversely quantizing, and inversely transforming the residual transform coefficient when the first path is selected.

According to another aspect of the present invention, there is provided a video data coding method comprising: generating a vector corresponding to a residual transform coefficient block obtained by transforming and quantizing a residual block that is a difference between a current block and a predicted block; searching for a reference vector that is most similar to the vector among reference vectors corresponding to residual transform coefficient blocks of a sampled picture; and performing entropy encoding on an index matching the searched reference vector; and inversely searching for a vector corresponding to the index from the reference vectors; and performing inverse quantization and inverse transformation on the residual transform coefficient block reconstructed from the inversely-searched vector.

According to another aspect of the present invention, there is provided a video data coding method comprising: selecting a path among paths where entropy encoding is performed on a residual transform coefficient obtained by transforming and quantizing a residual block that is a difference between a current block and a predicted block; and encoding path information on the selected path; and decoding the encoded residual transform coefficient based on the path information.

According to another aspect of the present invention, there is provided an encoding apparatus comprising: a transformation quantization unit which generates a vector corresponding to a residual transform coefficient obtained by transforming and quantizing a residual block that is a difference between a current block and a predicted block; an optimal vector searching unit which searches for a reference vector that is most similar to the vector among reference vectors corresponding to residual transform coefficient blocks of a sampled picture; and an entropy encoding unit which performs entropy encoding on an index matching the searched reference vector.

According to another aspect of the present invention, there is provided an encoding apparatus comprising: a transformation quantization unit which generates a residual transform coefficient by transforming and quantizing a residual block that is a difference between a current block and a predicted block; and a path selection unit which selects a path among paths where entropy encoding is performed on the residual transform coefficient.

According to another aspect of the present invention, there is provided an encoding apparatus comprising: a vector generation unit which generates vectors corresponding to residual coefficients; and a clustering unit which performing clustering on the vectors based on spatial nearness of the vectors.

According to another aspect of the present invention, there is provided a decoding apparatus comprising: an entropy decoding unit which receives vectors that correspond to residual transform coefficients obtained by transforming and quantizing a residual block that is a difference between a current block and a predicted block and performs entropy decoding on the vectors, wherein the vectors are allocated with indices; and a storage unit which stores the vectors with indices matching the vectors.

According to another aspect of the present invention, there is provided a decoding apparatus comprising: an entropy decoding unit which extracts from a bitstream including index information an index matching a vector corresponding to a residual transform coefficient obtained by transforming and quantizing a residual block that is a difference between a current block and a predicted block; and a reconstructing unit which reconstructs the residual block based on the extracted index.

According to another aspect of the present invention, there is provided a coding apparatus: a transformation quantization unit which generates a vector corresponding to a residual transform coefficient block obtained by transforming and quantizing a residual block that is a difference between a current block and a predicted block; an optimal vector searching unit which searches for a reference vector that is most similar to the vector among reference vectors corresponding to residual transform coefficient blocks of a sampled picture; an entropy encoding unit which performs entropy encoding on an index matching the searched reference vector; an optimal vector inversely-searching unit which inversely searches for a vector corresponding to the index from the reference vectors; and an inverse-quantization inverse-transformation unit which performs inverse quantization and inverse transformation on the residual transform coefficient block reconstructed from the inversely-searched vector.

According to another aspect of the present invention, there is provided a coding apparatus: a path selection unit which selects a path among paths where entropy encoding is performed on a residual transform coefficient obtained by transforming and quantizing a residual block that is a difference between a current block and a predicted block; an entropy encoding unit which encodes path information on the selected path; and a decoding unit which decodes the encoded residual transform coefficient based on the path information.

According to another aspect of the present invention, there is provided a computer-readable medium having embodied thereon a computer program for executing the video data encoding and decoding methods and the coding methods according to the aforementioned aspects of the present invention.

### DESCRIPTION OF THE DRAWINGS

FIG. 1 is a block diagram of a uni-path video data encoding apparatus according to an embodiment of the present invention.

FIG. 2 is a block diagram of a code book generation unit according to an embodiment of the present invention.

FIG. 3 is a view showing an operation of an optimal vector searching unit searching for a vector that is most similar to a residual transform coefficient from a code book according to an embodiment of the present invention.

FIG. 4 is a view showing an operation of reordering a code book in frames according to an embodiment of the present invention.

FIG. 5 is a block diagram of a dual-path video data encoding apparatus according to an embodiment of the present invention.

FIG. 6 is a block diagram of a uni-path video data decoding apparatus according to an embodiment of the present invention.

FIG. 7 is a block diagram of a dual-path video data decoding apparatus according to an embodiment of the present invention.

FIG. 8 is a flowchart for explaining a code book generating operation and a code book reordering operation according to an embodiment of the present invention.

FIG. 9 is a flowchart of a method of encoding a residual transform coefficient of video data according to an embodiment of the present invention.

FIG. 10 is a flowchart of a method of decoding a residual transform coefficient of video data according to an embodiment of the present invention.

FIG. 11 shows graphs of experimental results for video data encoding methods according to embodiments of the present invention.

### BEST MODE

Hereinafter, exemplary embodiments of the present invention are described in detail with reference to the accompanying drawings. Like reference numerals in the drawings denote like elements. Descriptions of well-know functions and components may be omitted for clarity.

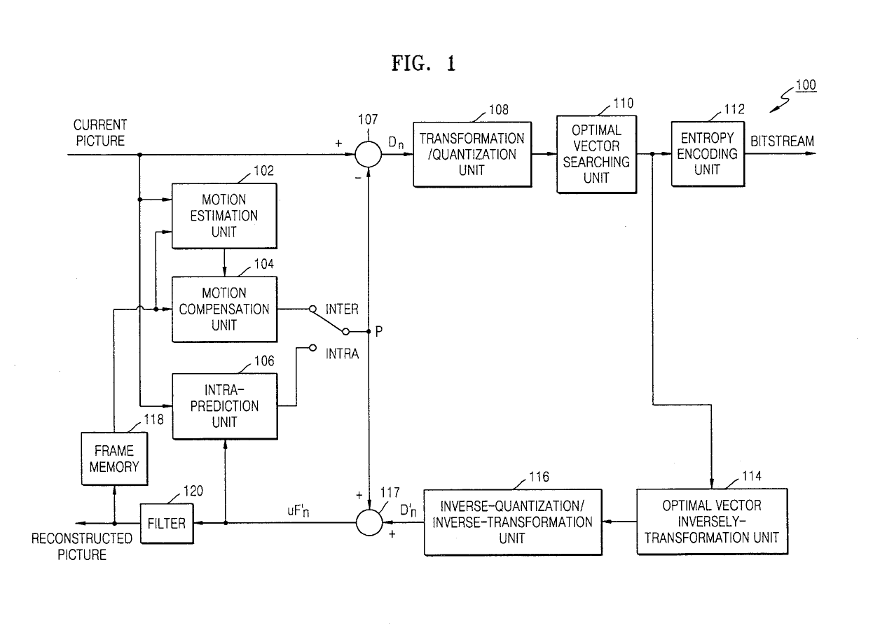

FIG. 1 is a block diagram of a uni-path video data encoding apparatus according to an embodiment of the present invention.

Referring to FIG. 1, the uni-path video data encoding apparatus 100 includes a motion estimation unit 102, a motion compensation unit 104, an intra-prediction unit 106, a subtraction unit 107, a transformation quantization unit 108, an optimal vector searching unit 110, an entropy encoding unit 112, an optimal vector inversely-searching unit 114, an inverse-quantization inverse-transformation unit 116, an addition unit 117, a frame memory 118, and a filter 120.

The motion estimation unit 102 performs motion estimation in order to search a region that is most similar to a current macroblock from a picture of a reference frame stored in the frame memory 118. More specifically, an area around the current macroblock in the reference frame is searched, and a region that is most similar to the current macroblock, that is, a region which has a minimum spatial difference from the current macroblock, is selected from the searched area. The spatial difference between the most similar region and the current block is output as a motion vector.

The motion compensation unit 104 reads the region that is most similar to the current macroblock from the picture of the reference frame stored in the frame memory 118 by using the motion vector to generate an inter-predicted block. Therefore, the motion estimation unit 102 and the motion compensation unit 104 cooperatively function as an inter-prediction unit which performs inter-prediction.

The inter-prediction may be performed on 16×8, 8×16, 8×8, 8×4, 4×8, 4×4 blocks as well as on a 16×16 macroblock.

The intra-prediction unit 106 performs intra-prediction by using correlation within the current frame.

When the predicted block corresponding to a currently to-be-encoded block is generated by performing the inter-prediction, the subtraction unit 107 calculates a difference between the current block and the predicted block to output a residual block that is a prediction difference block.

The transformation quantization unit (sometimes, referred to as a quantization transformation unit) 108 performs discrete cosine transformation (DCT) and quantization of the prediction difference block obtained by performing the inter-prediction in order to output a residual transform coefficient block and then reorders the residual transform coefficient block into a 1-D array by using zigzag scan and Run-Level encoding.

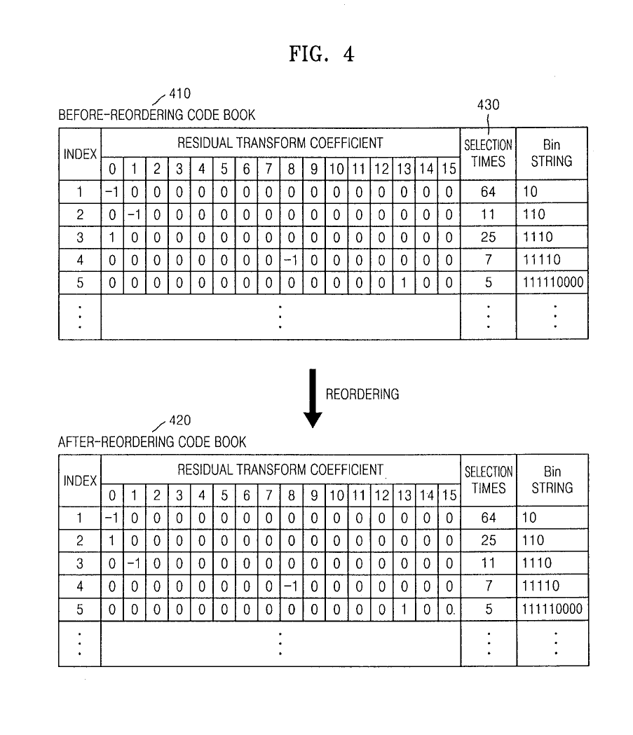

The optimal vector searching unit 110 searches for a vector that is most similar to a vector that is a 1-D array of the residual transform coefficient block obtained by performing the transformation and quantization in a code book, and detects an index matching the most similar vector. The aforementioned operations will be described later in detail with reference to FIG. 3.

The entropy encoding unit 112 encodes the index matching the most-similar vector by using a variable length coding (VLC) scheme to output a final bitstream.

The optimal vector inversely-searching unit 114 searches for the vector corresponding to the matched index from the code book in an inverse manner where the operations of the optimal vector searching unit 110 are inversely performed to select the vector.

The inverse-quantization inverse-transformation unit 116 (sometimes referred to as an inverse quantization transformation unit) performs inverse quantization and inverse transformation on the selected vector so as to output a residual block that is the prediction difference block.

The addition unit 117 adds the residual block to the inter-predicted block or the intra-predicted block. Finally, the picture is reconstructed by the filter 120.

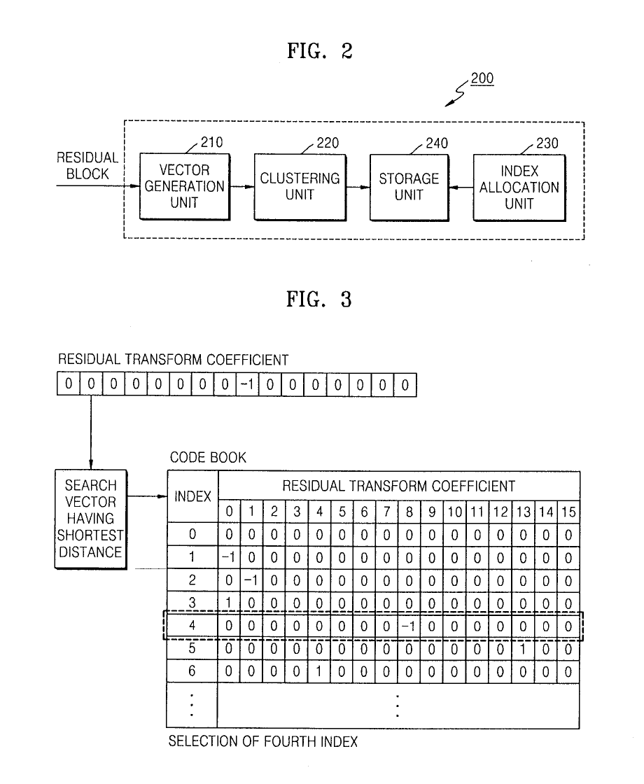

FIG. 2 is a block diagram of a code book generation unit according to an embodiment of the present invention. A code book is generated by using vector quantization.

Referring to FIG. 2, the code book generation unit 200 includes a vector generation unit 210, a clustering unit 220, an index allocation unit 230, and a storage unit 240.

The vector generation unit 210 generates vectors corresponding to residual coefficients. For example, a large number of residual transform coefficients in units of a 4×4 block, which are obtained by DCT and quantization of real sample pictures are reordered as a 16×1 vector in a space.

The residual coefficient may be any one of a residual transform coefficient obtained by performing motion compensated transformation, a residual transform coefficient obtained by transforming a residual block that is a difference between a current block and a predicted block, and a residual transform coefficient obtained by transforming and quantizing the residual block. Hereinafter, an embodiment of the present invention is described by using the residual transform coefficient obtained by transforming the residual block that is a difference between the current block and the predicted block. However, it should be noted that the same description of the present embodiment can be applied to other residual coefficients.

The clustering unit 220 performs clustering of the residual transform coefficients by using a clustering analysis algorithm. The clustering is an operation of generating a code book by clustering objects near to each other based on positions thereof in a 16-D space of the reordered vectors. As an example of the clustering analysis algorithm, a K-means algorithm may be used.

According to the present embodiment, the clustering includes clustering of residual coefficients (residual data) obtained by a motion compensated (MC) transform coder, clustering of quantized residual signals of transformed signals, and clustering of transformed residual signals.

The residual transform coefficients greatly depend on a quantization parameter. The residual transform coefficients may be distributed in units of a clustering number that suits the quantization parameter. For example, a range of the quantization parameter is partitioned into predetermined regions, and the residual transform coefficients may be clustered in units of a clustering number that suits each of the predetermined regions.

A code book of the clustered residual transform coefficients is an M×N table in which M represents the number of to-be-allocated indices and N represents a dimension of residual block vectors.

The storage unit 240 stores the code book as an initial code book. When the vectors of the code book are reordered later, the storage unit 240 stores the code book of the reordered vectors.

The index allocation unit 230 allocates the indices and Bin strings that are binarized values of the indices to the vectors of the code book. The binarization of the indices is needed so as to encode the indices in Context Adaptive Binary Arithmetic Coding (CABAC) that is an entropy encoding scheme. In the binarization, an input symbol is represented by the Bin string, that is, a combination of 0 and 1. As a length of the Bin stringing becomes shorter, the symbol can be encoded with a smaller number of bits. Therefore, in order to efficiently binarize the indices, the vectors after the clustering may be reordered in a descending order of a clustering density. As a result, a vector having a higher clustering density can have a shorter Bin string. As an example of the binarization, unary 3rd order exponential Golomb coding may be used. In the embodiment of the present invention, unary is used for the four upper vectors.

Table 1 is an example of a code book representing clustered 16×1 vectors, indices allocated to the vectors, and Bin strings obtained by the aforementioned binarization of the indices. In particular, in the example, there are a large number of residual transform coefficients of 0. Therefore, by using 1-bit flags, a vector having all the residual transform coefficients of 0 is distinguished from other vectors, so that encoding efficiency can be increased.

TABLE 1

| | 4 × 4 Coefficient | | | | | | | | | | | | | | | | | |
|---|---|---|---|---|---|---|---|---|---|---|---|---|---|---|---|---|---|---|
| Index | 0 | 1 | 2 | 3 | 4 | 5 | 6 | 7 | 8 | 9 | 10 | 11 | 12 | 13 | 14 | 15 | Prob(%) | Bin string |
| 0 | 0 | 0 | 0 | 0 | 0 | 0 | 0 | 0 | 0 | 0 | 0 | 0 | 0 | 0 | 0 | 0 | 88.24 | 0 |
| 1 | −1 | 0 | 0 | 0 | 0 | 0 | 0 | 0 | 0 | 0 | 0 | 0 | 0 | 0 | 0 | 0 | 10.48 | 10 |
| 2 | 1 | 0 | 0 | 0 | 0 | 0 | 0 | 0 | 0 | 0 | 0 | 0 | 0 | 0 | 0 | 0 | 6.50 | 110 |
| 3 | 0 | −1 | 0 | 0 | 0 | 0 | 0 | 0 | 0 | 0 | 0 | 0 | 0 | 0 | 0 | 0 | 6.28 | 1110 |
| 4 | 0 | 0 | 0 | 0 | 0 | 0 | 0 | 0 | −1 | 0 | 0 | 0 | 0 | 0 | 0 | 0 | 5.12 | 11110 |
| 5 | 0 | 0 | 0 | 0 | 0 | 0 | 0 | 0 | 0 | 0 | 0 | 0 | 0 | 1 | 0 | 0 | 4.70 | 111110000 |
| 6 | 0 | 0 | 0 | 0 | 1 | 0 | 0 | 0 | 0 | 0 | 0 | 0 | 0 | 0 | 0 | 0 | 4.84 | 111110001 |
| 7 | 0 | 0 | 1 | 0 | 0 | 0 | 0 | 0 | 0 | 0 | 0 | 0 | 0 | 0 | 0 | 0 | 4.08 | 111110010 |
| 8 | 0 | 0 | 0 | 0 | 0 | 0 | 0 | 0 | 1 | 0 | 0 | 0 | 0 | 0 | 0 | 0 | 3.63 | 111110011 |
| 9 | 0 | 0 | −1 | 0 | 0 | 0 | 0 | 0 | 0 | 0 | 0 | 0 | 0 | 0 | 0 | 0 | 3.29 | 111110100 |
| 10 | 0 | 0 | 0 | 1 | 0 | 0 | 0 | 0 | 0 | 0 | 0 | 0 | 0 | 0 | 0 | 0 | 2.99 | 111110101 |
| 11 | 0 | 0 | 0 | −1 | 0 | 0 | 0 | 0 | 0 | 0 | 0 | 0 | 0 | 0 | 0 | 0 | 2.81 | 111110110 |
| 12 | 0 | 0 | 0 | 0 | 0 | 1 | 0 | 0 | 0 | 0 | 0 | 0 | 0 | 0 | 0 | 0 | 2.77 | 111110111 |
| 13 | 0 | 0 | 0 | 0 | 0 | −1 | 0 | 0 | 0 | 0 | 0 | 0 | 0 | 0 | 0 | 0 | 2.73 | 111111000000 |
| 14 | 0 | 0 | 0 | 0 | 0 | 0 | 1 | 0 | 0 | 0 | 0 | 0 | 0 | 0 | 0 | 0 | 2.60 | 111111000001 |
| 15 | 0 | 0 | 0 | 0 | 0 | 0 | 0 | −1 | 0 | 0 | 0 | 0 | 0 | 0 | 0 | 0 | 1.89 | 111111000010 |

| | | | |
|---|---|---|---|
| . | . | . | . |
| . | . | . | . |
| . | . | . | . |

FIG. 3 is a view showing an operation of an optimal vector searching unit searching for a vector that is most similar to a residual transform coefficient from a code book according to an embodiment of the present invention.

Referring FIG. 3, it can be seen that a vector corresponding to a 4-th index is selected. The selection of the most similar vector is performed by using a Euclean distance equation represented by Equation 1.

All the distances of the residual transform coefficient from all the vectors of the code book are calculated by using Equation 1, and a vector having the shortest distance is determined as an optimal vector, that is, the most-similar vector. If a distance from a vector is calculated to be 0, the distance calculation for subsequent vectors does not proceed, and the vector is determined as the optimal vector.

$$Distance ( C , R ) = \sqrt{{\sum }_{k = 0}^{15} {( {C}_{k} - {R}_{k} )}^{2}} \qquad [ Equation 1 ]$$

Here, “C” denotes an arbitrary 16×1 vector of the code book, and “R” denotes a residual transform coefficient. In addition, “Distance” denotes a Euclean distance between a residual transform coefficient and an arbitrary vector of the code book.

When the vector having the shortest distance is determined, the index corresponding to the vector is encoded by the entropy encoding unit.

FIG. 4 is a view showing an operation of reordering a code book in frames (hereinafter, referred to as a frame-by-frame code book reordering operation) according to an embodiment of the present invention.

Referring to FIG. 4, in the frame-by-frame code book reordering operation, during compression of each frame, selection times for each residual transform coefficient corresponding to each index is stored. When one frame is encoded, the vectors of the code book are reordered in a descending order of the selection times. Therefore, a smaller number of bits can be used to adaptively encode the indices according to time and picture types. Namely, as the value of an index becomes larger, the length of the corresponding Bin string becomes longer. Just before the encoding of a current frame, a distribution of probabilities of indices to the previous frame is calculated, and by using the probabilities of the indices, the vectors of the code book are reordered in the descending order of the probabilities of the indices. As a result of the table reordering (code book reordering), the indices are reallocated from Index 0 at the uppermost of the code book.

The aforementioned code book reordering operation for the encoder can be performed on a decoder storing the same code book. Accordingly, any additional parameters need to be transmitted.

However, the frame-by-frame code book reordering also needs to be performed on the decoder, so that calculation complexity increases. In order to reduce the calculation complexity, the reordering is only performed on about 20 upper indices. Accordingly, it is possible to improve performance of reordering in comparison with the existing reordering scheme.

In FIG. 4, a code book 410 is a before-reordering code book. The code book 410 shows the selection times 430 of the vectors corresponding to the indices used for one frame encoding. Here, “selection Times” 430 denotes the selection times of the vectors used in the code book 410.

In FIG. 4, a code book 420 is an after-reordering code book which is reordered according to the selection times 430. If the vector of Index 3 having large selection times (25) and the vector of Index 2 having small selection times (11) are reordered so as to exchange positions with each other in the code book 410, the vector of Index 3 having the larger selection times has a shorter Bin string in the code book 420. In particular, since the vector having all the residual transform coefficients of 0 is used in all the frames by the largest selection times, the vector does not need to be reordered, and the vector can be always positioned at Index 0 in a code book (not shown).

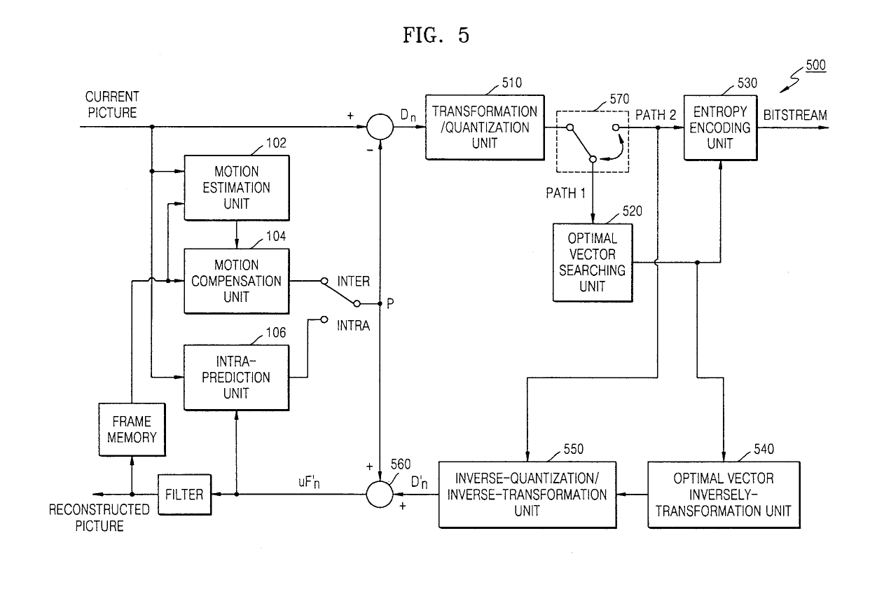

FIG. 5 is a block diagram of a dual-path video data encoding apparatus according to an embodiment of the present invention.

Referring to FIG. 5, the dual-path video data encoding apparatus 500 has a construction similar to that of the aforementioned uni-path video data encoding apparatus 100. However, in the dual-path video data encoding apparatus 500, the residual transform coefficient block generated by DCT and quantization of the transformation quantization unit 510 is arranged to proceed to two paths (Paths 1 and 2) at a branch point.

The dual-path video data encoding apparatus 500 includes a transformation quantization unit 510, an optimal vector searching unit 520, an entropy encoding unit 530, an optimal vector inversely-searching unit 540, an inverse-quantization inverse-transformation unit 550, an addition unit 560, and a path selection unit 570. For simplicity, a detailed description of the components that are the same as those of the aforementioned uni-path video data encoding apparatus 100 is omitted.

The path selection unit 570 selects a path (Path 1 or 2) to allow the residual transform coefficient to proceed to the corresponding paths and to perform an entropy encoding.

Path 1 corresponds to the operation of the aforementioned uni-path video data encoding apparatus 100. In Path 1, the optimal vector searching unit 520 searches for a vector that is most similar to a 16×1 vector corresponding to a 1-D array of the residual transform coefficient blocks in the code book, and the entropy encoding unit 530 performs entropy encoding on the index matching the most similar vector.

Path 2 corresponds to an existing standard compression operation. In Path 2, without selection and transformation of indices performed based on the code book by the optimal vector searching unit 520, the residual transform coefficient blocks are input to the entropy encoding unit 530.

A scheme for comparing a rate-distortion cost (RD cost) of Path 1 with the RD cost of Path 2 and for selecting a path having a smaller RD cost is used as a path selection scheme for the encoding of the residual transform coefficients of the current macroblock.

In addition, a flag bit (one bit per macroblock) which is inserted into the bitstream to represent a path may be transmitted to the decoder to identify the used path. Accordingly, the decoding can be performed according to the used path.

$$RDCost = Distortion + {λ}_{mode} \times Rates \\ Distortion = {\sum }_{k = 1}^{16} {\sum }_{l = 1}^{16} \vert B ( k , l ) - {B}^{′} ( k , l ) \vert \\ {λ}_{mode} = 0.85 \times {2}^{\frac{QP - 12}{3}} \qquad [ Equation 2 ]$$

The RD cost can be calculated by using Equation 2 represented by a Lagrangian cost function. In Equation 2, “Rates” denotes the amount of bits used for encoding the residual transform coefficient, and “Distortion” denotes a degree of distortion of a reconstructed macroblock with respect to an original macroblock, in which the degree of distortion is calculated based on a sum of square difference (SSD). B(k,l) denotes a value of a pixel (k,l) of the original macroblock, and B′(k,l) denotes a value of a pixel (k,l) of the reconstructed macroblock. λ is a constant determined according to a quantization parameter.

The index of the vector encoded through Path 1 is input to the optimal vector inversely-searching unit 540 which searches for the vector corresponding to the index. The corresponding vector is subjected to inverse-quantization and inverse-transformation operations in the inverse-quantization inverse-transformation unit 550 and, subsequently, added to the inter-predicted block in the addition unit 560, so that a picture can be reconstructed.

The residual transform coefficient encoded through Path 2 is subjected to the inverse-quantization and inverse-transformation operations in the inverse-quantization inverse-transformation unit 550, and subsequently, added to the inter-predicted block in the addition unit 560, so that a picture can be reconstructed.

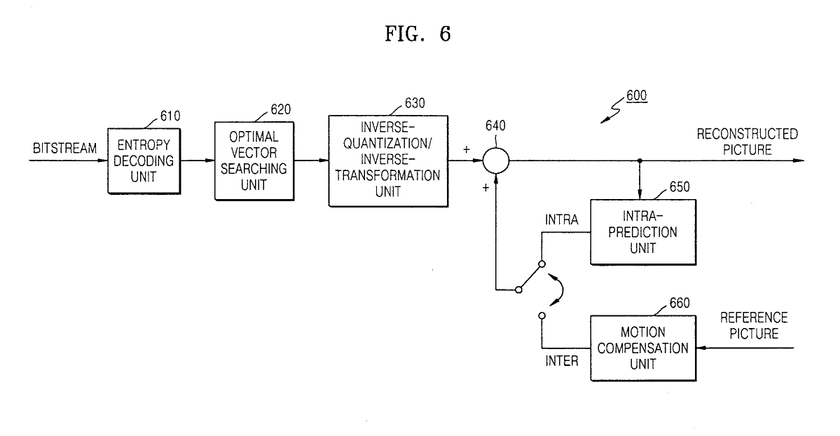

FIG. 6 is a block diagram of a uni-path video data decoding apparatus according to an embodiment of the present invention.

Referring to FIG. 6, the uni-path video data decoding apparatus 600 includes an entropy decoding unit 610, an optimal vector inversely-searching unit 620, an inverse-quantization inverse-transformation unit 630, an addition unit 640, an intra-prediction unit 650, and a motion compensation unit 660.

When the entropy decoding unit 610 receives a bitstream including an index matching a vector corresponding to the residual transform coefficient obtained by transforming and quantizing a residual block that is a difference between the current block and the predicted block, the entropy decoding unit 610 performs entropy decoding on the bitstream in order to output the index.

The optimal vector inversely-searching unit 620 searches for a vector corresponding to the index output from the entropy decoding unit 610 from a code book that is stored in the decoding apparatus in advance, so that the residual transform coefficient block can be reconstructed from the vector.

The code book of the decoder (or decoding apparatus) is obtained by receiving from the encoder (or encoding apparatus) an M×N table of clustered vectors of the residual transform coefficients of a large number of sampled pictures and decoding and storing the table. In the M×N table, “M” denotes the number of indices, and “N” denotes a dimension of residual transform coefficients. Alternatively, in order to reduce calculation complexity in the decoder, a table of residual coefficients may be generated by performing inverse quantization and inverse transformation on the residual transform coefficients matching the indices of the code book in advance. Accordingly, without the inverse quantization and the inverse transformation of the residual transform coefficients corresponding to the received indices, the residual coefficients can be obtained by directly looking up the table.

In addition, similar to the aforementioned encoder, probabilities of indices received in frames may be calculated according to the selection times of the vectors corresponding to the indices. The vectors of the code book may be reordered in a descending order of the probabilities, and the indices are reallocated to the vectors.

The inverse-quantization inverse-transformation unit 630 performs the inverse quantization and the inverse transformation on the reconstructed residual transform coefficient blocks in order to generate residual coefficient blocks.

The motion compensation unit 660 generates predicted blocks. The predicted blocks are added to the residual coefficient blocks in the addition unit 640, so that the picture can be reconstructed.

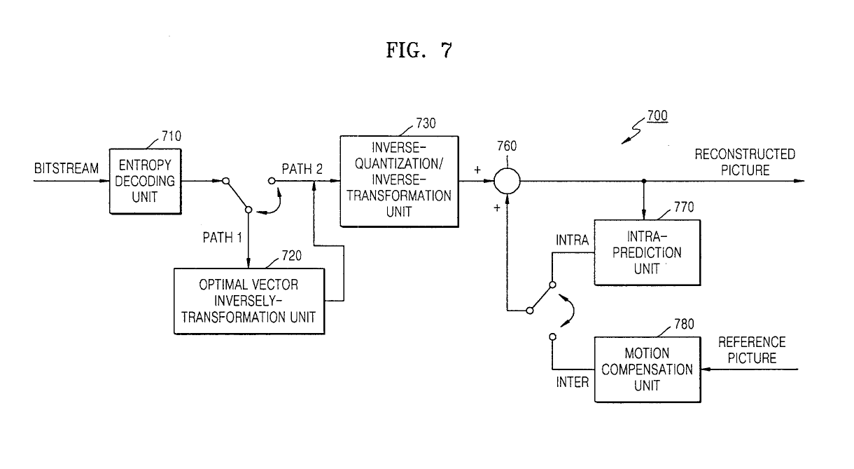

FIG. 7 is a block diagram of a dual-path video data decoding apparatus according to an embodiment of the present invention. For simplicity, a detailed description of the components that are the same as those of the aforementioned uni-path video data decoding apparatus 600 is omitted.

Referring to FIG. 7, the dual-path video data decoding apparatus 700 includes an entropy decoding unit 710, an optimal vector inversely-searching unit 720, an inverse-quantization inverse-transformation unit 730, and an addition unit 760.

The entropy decoding unit 710 extracts path information from a received bitstream. A flag bit (one bit), which is inserted into the bitstream to represent a path, is decoded. The path (Path 1 or 2) is selectively changed according to the flag bit.

When Path 1 is selected, the entropy decoding unit 710 performs entropy decoding on the bitstream in an decoding scheme that is the same as that of the uni-path video data decoding apparatus 600 in order to extract the index. When Path 2 is selected, the residual transform coefficient blocks are subjected to the entropy decoding.

The optimal vector inversely-searching unit 720 searches for the vector corresponding to the extracted index from the code book and selects the vector.

The inverse-quantization inverse-transformation unit 730 performs the inverse quantization and the inverse transformation on the residual transform coefficient block corresponding to the selected vector and the residual transform coefficient block obtained through Path 2 in order to generate a residual coefficient block.

The motion compensation unit 780 generates predicted blocks. The predicted blocks are added to the residual coefficient blocks output through Path 1 or 2 in the addition unit 760, so that the picture can be reconstructed.

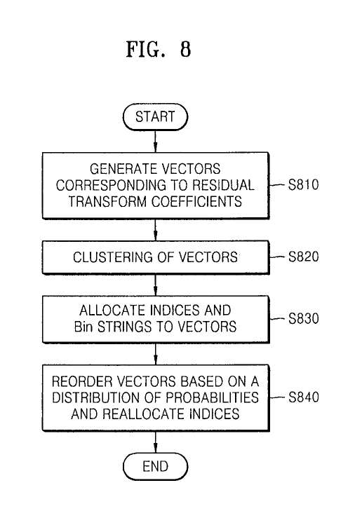

FIG. 8 is a flowchart for explaining a code book generating operation and a code book reordering operation according to an embodiment of the present invention.

Referring to FIG. 8, in the code book generating operation, a vector corresponding to a residual coefficient is generated (S810). The residual coefficient may be any one of a residual transform coefficient obtained by performing motion compensated transformation on a sampled picture, a residual transform coefficient obtained by transforming a residual block that is a difference between a current block and a predicted block, and a residual transform coefficient obtained by transforming and quantizing the residual block.

Next, a code book which is obtained by clustering the vectors based on spatial nearness is stored (S820). The code book is an M×N table of vectors, in which “M” and “N” denote the number of indices and a dimension of residual transform coefficients, respectively.

The indices and Bin strings that are binarized values of the indices are allocated to the clustered vectors (S830).

In an initial code book allocated initial indices and Bin strings, the selection times of the vectors corresponding to the indices selected in frames of an input video are calculated. The vectors of the code book are reordered according to a distribution of probabilities of indices per frame in a descending order of probabilities of indices, and the indices are also reallocated (S840).

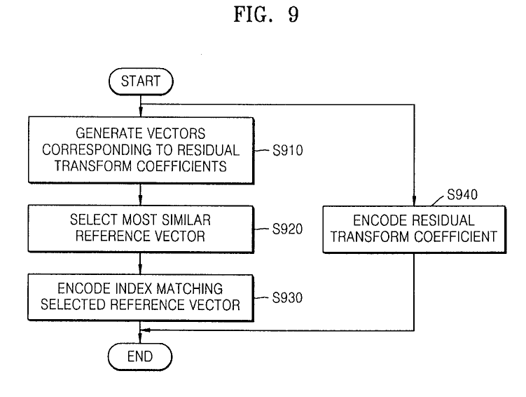

FIG. 9 is a flowchart of a method of encoding a residual transform coefficient of video data according to an embodiment of the present invention.

Referring to FIG. 9, a residual block that is a difference between a current block and an predicted block of input video data is subjected to transformation and quantization in a transformation quantization unit in order to generate a vector that is a 1-D array of the residual transform coefficient block (S910).

An optimal vector searching unit searches for an optimal vector that is most similar to the vector from a code book that is a table of reference vectors which are stored in advance and selects the optimal vector (S920).

Next, an entropy encoding unit performs entropy encoding on an index matching the selected optimal vector to generate a final bitstream (S930).

In addition, a path selection operation may be provided. In the path selection operation, an RD cost for a path where an optimal vector searching process for a to-be-encoded vector and an index encoding process are performed and an RD cost for another path where the residual transform coefficients are subjected to the entropy encoding without selection of indices are calculated and compared with each other, and the path having a smaller RD cost is selected.

Accordingly, unlike the aforementioned method, the residual transform coefficient blocks can be selectively subjected to the entropy encoding similarly to an existing method (S940).

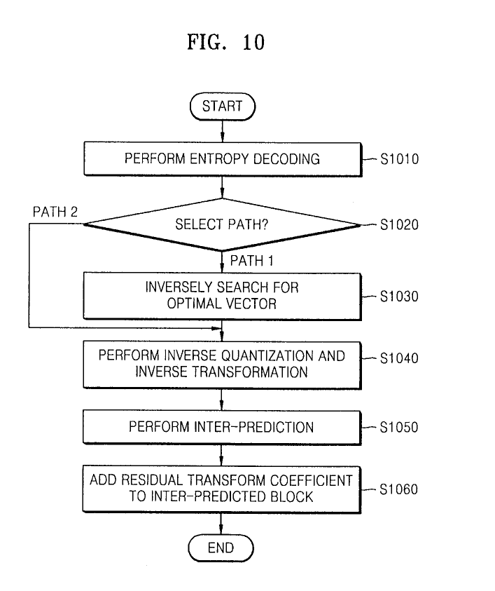

FIG. 10 is a flowchart of a method of decoding a residual transform coefficient of video data according to an embodiment of the present invention.

Referring to FIG. 10, an entropy decoding unit performs entropy decoding on a received bitstream where indices are encoded by using a code book (S1010).

A flag bit, which is inserted into the bitstream to represent a path, is decoded, and the paths are selectively changed according to the flag bit (S1020).

For example, if the flag bit is 0, an optimal vector corresponding to the index is searched for from a code book including decoded indices in advance and which is the same as a code book of an encoder in an inverse manner to output a residual transform coefficient block (S1030).

If the flag bit is 1, the residual transform coefficient block is decoded by the entropy decoding unit, and subsequently, an inverse quantization operation is performed.

The decoded residual transform coefficient block is subjected to the inverse quantization and the inverse transformation in the inverse quantization inverse transformation unit in order to generate a residual coefficient block (S1040).

The motion compensation unit performs inter prediction by using the video data included in the bitstream to generate a predicted block (S1050).

The residual coefficient block generated by the inverse-quantization inverse-transformation unit is added to the predicted block generated by the motion compensation unit, so that a picture is reconstructed (S1060).

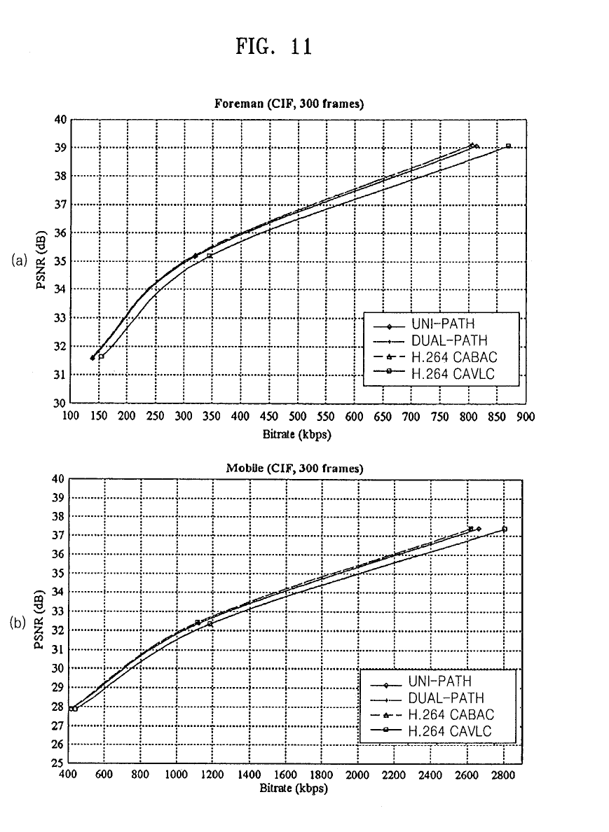

FIG. 11 shows graphs of experimental results for video data encoding methods according to embodiments of the present invention.

Referring to FIG. 11, Graph (a) shows an R-D curve of a Foreman picture, and Graph (b) shows an R-D curve of a Mobile picture.

Each of the R-D curve (a) of the Foreman picture and the R-D curve (b) of the Mobile pictures shows experimental results of performance of video data encoding methods (uni-path and dual-path) according to embodiments of the present invention and encoding methods using H.264 CABAC and H.264 context-adaptive variable length coding (CAVLC) of joint model (JM) 8.6, that is, an H.264 reference encoder.

As the experimental conditions, 300 frames (352×288 30 Hz) of pictures are used, and the experiment is carried out at quantization parameters (QP)24, QP30, and QP36. In addition, variable length motion estimation, rate-distortion optimization, IPPP structure, 30-frame-period intra frame, 5 reference frames, and ±16 motion vector searching regions are used.

In comparison with the H.264 CAVLC, the video data encoding methods according to the embodiments of the present invention shows a high performance of 0.3 dB to 0.5 dB, which is substantially equal to performance of the H.264 CABAC.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

### ADVANTAGEOUS EFFECTS

According to the present invention, indices corresponding to residual transform coefficients obtained by performing DCT and quantization are encoded and transmitted, so that it is possible to increase compression ratio.

In addition, a table of residual coefficients obtained by performing inverse quantization and inverse DCT (or other inverse transformation) is stored, and a residual coefficient corresponding to an index included in a received bitstream is searched for by looking up the table, so that inverse DCT and inverse quantization operations can be omitted. Accordingly, it is possible to reduce calculation complexity.

In addition, existing encoding and decoding methods and encoding or decoding methods using a code book can be selectively carried out, so that it is possible to implement efficient encoding and decoding.

1. A video data encoding method comprising:
generating a vector corresponding to a residual transform coefficient obtained by transforming and quantizing a residual block that is a difference between a current block and a predicted block;
searching for a reference vector that is most similar to the vector among reference vectors corresponding to residual transform coefficient blocks of a sampled picture; and
performing entropy encoding on an index matching the searched reference vector.

2. The video data encoding method of claim 1, wherein the searching for the reference vector comprises:
calculating a Euclean distance between the vector and the reference vectors; and
selecting the reference vector having the shortest Euclean distance.

3. A video data encoding method comprising:
generating a residual transform coefficient by transforming and quantizing a residual block that is a difference between a current block and a predicted block; and
selecting a path among paths where entropy encoding is performed on the residual transform coefficient.

4. The video data encoding method of claim 3, wherein the selecting of the path comprises:
calculating a first RD (rate-distortion) cost of a first path where the entropy encoding is performed on the residual transform coefficient;
calculating a second RD cost of a second path where a vector corresponding to the residual transform coefficient is generated and the entropy encoding is performed on an index matching a reference vector that is most similar to the vector among reference vectors of residual transform coefficients of a sampled picture; and
comparing the first RD cost with the second RD cost and selecting the path having a smaller RD cost.

5. The video data encoding method of claim 3, further comprising encoding information on the selected path.

6. A video data encoding method comprising:
generating vectors corresponding to residual coefficients; and
clustering the vectors based on spatial nearness of the vectors.

7. The video data encoding method of claim 6, wherein the residual coefficient is any one of a residual transform coefficient obtained by performing motion compensated transformation, a residual transform coefficient obtained by transforming a residual block that is a difference between a current block and a predicted block, and a residual transform coefficient obtained by transforming and quantizing the residual block.

8. The video data encoding method of claim 6, further comprising allocating indices and Bin strings that are binarized values of the indices to the vectors.

9. The video data encoding method of claim 8,
wherein the clustering of the vectors comprises constructing an M×N table of the vectors, and
wherein M is the number of indices, and N is a dimension of the residual block.

10. The video data encoding method of claim 8, further comprising reallocating the indices after reordering the vectors based on a distribution of probabilities of vectors per frame in a descending order of the probabilities.

11. The video data encoding method of claim 10, wherein the reallocating of the indices is performed on only some of upper vectors.

12. A video data decoding method comprising:
receiving vectors that correspond to residual transform coefficients obtained by transforming and quantizing a residual block that is a difference between a current block and a predicted block, wherein the vectors are allocated with indices; and
performing entropy decoding on the vectors and storing the vectors with indices matching the vectors.

13. The video data decoding method of claim 12, further comprising reallocating the indices after reordering the vectors based on a distribution of probabilities of vectors per frame in a descending order of the probabilities.

14. The video data decoding method of claim 13, further comprising storing residual block data reconstructed by inversely quantizing and inversely transforming Bin strings that are binarized values of the indices with the indices matching the residual block data.

15. The video data decoding method of claim 13, wherein the reallocating of the indices is performed on only some of upper vectors.

16. A video data decoding method comprising:
extracting from a bitstream including index information an index matching a vector corresponding to a residual transform coefficient obtained by transforming and quantizing a residual block that is a difference between a current block and a predicted block; and
reconstructing the residual block based on the extracted index.

17. The video data decoding method of claim 16, wherein the reconstructing of the residual block comprises:
searching for a reference vector matching an index that is the same as the extracted index from reference vectors that are stored in advance;
reconstructing a residual transform coefficient corresponding to the searched reference vector; and
performing inverse quantization and inverse transformation on the reconstructed residual transform coefficient.

18. The video data decoding method of claim 16, wherein the reconstructing of the residual block comprises looking up a table which stores residual blocks reconstructed by inversely quantizing and inversely transforming Bin strings that are binarized values of indices with the indices matching the residual blocks and selecting a residual block matching an index that is the same as the extracted index from the table.

19. The video data decoding method of claim 17, further comprising reallocating the indices after reordering the reference vectors based on a distribution of probabilities of received vectors per frame in a descending order of the probabilities.

20. A video data decoding method comprising:
extracting path information from a bitstream, wherein the path information includes information on a first path where a residual transform coefficient obtained by transforming and quantizing a residual block that is a difference between a current block and a predicted block is decoded and a second path where an index corresponding to the residual transform coefficient is decoded; and
reconstructing the residual block that is the difference between the current block and the predicted block by performing entropy decoding, inversely quantizing, and inversely transforming the residual transform coefficient when the first path is selected.

21. The video data decoding method of claim 20, further comprising reconstructing the residual block by performing entropy decoding on the index, selecting a reference vector matching the index from reference vectors that are stored in advance, and performing inverse quantization and inverse transformation when the second path is selected.

22. The video data decoding method of claim 20, further comprising looking up a table which stores residual blocks reconstructed by inversely quantizing and inversely transforming Bin strings that are binarized values of indices with the indices matching the residual blocks and selecting a residual block matching an index that is the same as the extracted index from the table when the second path is selected.

23. A video data coding method comprising:
generating a vector corresponding to a residual transform coefficient block obtained by transforming and quantizing a residual block that is a difference between a current block and a predicted block;
searching for a reference vector that is most similar to the vector among reference vectors corresponding to residual transform coefficient blocks of a sampled picture; and
performing entropy encoding on an index matching the searched reference vector;
inversely searching for a vector corresponding to the index from the reference vectors; and
performing inverse quantization and inverse transformation on the residual transform coefficient block reconstructed from the inversely-searched vector.

24. The video data decoding method of claim 23, further comprising reallocating indices after reordering the reference vectors based on a distribution of probabilities of generated vectors per frame in a descending order of the probabilities.

25. A video data coding method comprising:
selecting a path among paths where entropy encoding is performed on a residual transform coefficient obtained by transforming and quantizing a residual block that is a difference between a current block and a predicted block; and
encoding path information on the selected path; and
decoding the encoded residual transform coefficient based on the path information.

26. The video data coding method of claim 25, wherein the selecting of the path comprises:
calculating a first RD (rate-distortion) cost of a first path where the entropy encoding is performed on the residual transform coefficient;
calculating a second RD cost of a second path where a vector corresponding to the residual transform coefficient is generated and the entropy encoding is performed on an index matching a reference vector that is most similar to the vector among reference vectors of residual transform coefficients of a sampled picture; and
comparing the first RD cost with the second RD cost and selecting the path having a smaller RD cost.

27. The video data coding method of claim 26, wherein the decoding comprises:
extracting the path information;
reconstructing the residual block by performing entropy decoding, inversely quantizing, and inversely transforming the residual transform coefficient when the path information on a first path is extracted.
reconstructing the residual block by selecting a reference vector matching the index from reference vectors that are stored in advance and performing inverse quantization and inverse transformation when the path information on a second path is extracted.

28. An encoding apparatus comprising:
a transformation quantization unit which generates a vector corresponding to a residual transform coefficient obtained by transforming and quantizing a residual block that is a difference between a current block and a predicted block;
an optimal vector searching unit which searches for a reference vector that is most similar to the vector among reference vectors corresponding to residual transform coefficient blocks of a sampled picture; and
an entropy encoding unit which performs entropy encoding on an index matching the searched reference vector.

29. The encoding apparatus of claim 28, wherein the optimal vector searching unit calculates a Euclean distance between the vector and the reference vectors, and selects the reference vector having the shortest Euclean distance.

30. An encoding apparatus comprising:
a transformation quantization unit which generates a residual transform coefficient by transforming and quantizing a residual block that is a difference between a current block and a predicted block; and
a path selection unit which selects a path among paths where entropy encoding is performed on the residual transform coefficient.

31. The encoding apparatus of claim 30,
wherein the path selection unit comprises a calculation unit which calculates first RD (rate-distortion) cost of a first path where the entropy encoding is performed on the residual transform coefficient and calculates a second RD cost of a second path where a vector corresponding to the residual transform coefficient is generated and the entropy encoding is performed on an index matching a reference vector that is most similar to the vector among reference vectors of residual transform coefficients of a sampled picture, and
wherein the calculation unit compares the first RD cost with the second RD cost and selects the path having a smaller RD cost.

32. The encoding apparatus of claim 30, further comprising an entropy encoding unit which encodes information on the selected path.

33. An encoding apparatus comprising:
a vector generation unit which generates vectors corresponding to residual coefficients; and
a clustering unit which performing clustering on the vectors based on spatial nearness of the vectors.

34. The encoding apparatus of claim 33, wherein the residual coefficient is any one of a residual transform coefficient obtained by performing motion compensated transformation, a residual transform coefficient obtained by transforming a residual block that is a difference between a current block and a predicted block, and a residual transform coefficient obtained by transforming and quantizing the residual block.

35. The encoding apparatus of claim 33, further comprising an index allocation unit which allocates indices and Bin strings that are binarized values of the indices to the vectors.

36. The encoding apparatus of claim 33,
wherein the clustering unit constructs an M×N table of the vectors, and
wherein M is the number of indices, and N is a dimension of the residual block.

37. The encoding apparatus of claim 35, wherein the index allocation unit reallocates the indices after reordering the vectors based on a distribution of probabilities of vectors per frame in a descending order of the probabilities.

38. A decoding apparatus comprising:
an entropy decoding unit which receives vectors that correspond to residual transform coefficients obtained by transforming and quantizing a residual block that is a difference between a current block and a predicted block and performs entropy decoding on the vectors, wherein the vectors are allocated with indices; and
a storage unit which stores the vectors with indices matching the vectors.

39. The decoding apparatus of claim 38, further comprising an index allocation unit which reallocates the indices after reordering the vectors based on a distribution of probabilities of vectors per frame in a descending order of the probabilities.

40. The decoding apparatus of claim 38, wherein the storage unit stores residual block data reconstructed by inversely quantizing and inversely transforming Bin strings that are binarized values of the indices with the indices matching the residual block data.

41. A decoding apparatus comprising:
an entropy decoding unit which extracts from a bitstream including index information an index matching a vector corresponding to a residual transform coefficient obtained by transforming and quantizing a residual block that is a difference between a current block and a predicted block; and
a reconstructing unit which reconstructs the residual block based on the extracted index.

42. The decoding apparatus of claim 41, wherein the reconstructing unit comprises:
an optimal vector inversely-searching unit which searches for a reference vector matching an index that is the same as the extracted index among reference vectors that are stored in advance;
a residual transform coefficient generation unit which reconstructs a residual transform coefficient corresponding to the searched reference vector; and
an inverse-quantization inverse-transformation unit which performs inverse quantization and inverse transformation on the reconstructed residual transform coefficient.

43. The decoding apparatus of claim 41, wherein the reconstructing unit comprises a residual block inversely-searching unit which looks up a table which stores residual blocks reconstructed by inversely quantizing and inversely transforming Bin strings that are binarized values of indices with the indices matching the residual blocks and selects a residual block matching an index that is the same as the extracted index from the table.

44. The decoding apparatus of claim 42, wherein, after the reference vectors are reordered based on a distribution of probabilities of received vectors per frame in a descending order of the probabilities, the reference vectors are reallocated with indices.

45. The decoding apparatus of claim 41, wherein the entropy decoding unit extracts path information form a bitstream, wherein the path information includes information on a first path where a residual transform coefficient is decoded and a second path where an index corresponding to the residual transform coefficient is decoded.

46. A coding apparatus:
a transformation quantization unit which generates a vector corresponding to a residual transform coefficient block obtained by transforming and quantizing a residual block that is a difference between a current block and a predicted block;
an optimal vector searching unit which searches for a reference vector that is most similar to the vector among reference vectors corresponding to residual transform coefficient blocks of a sampled picture;
an entropy encoding unit which performs entropy encoding on an index matching the searched reference vector;
an optimal vector inversely-searching unit which inversely searches for a vector corresponding to the index from the reference vectors; and
an inverse-quantization inverse-transformation unit which performs inverse quantization and inverse transformation on the residual transform coefficient block reconstructed from the inversely-searched vector.

47. The coding apparatus of claim 46, wherein the optimal vector searching unit calculates a Euclean distance between the vector and the reference vectors and selects the reference vector having the shortest Euclean distance.

48. A coding apparatus:
a path selection unit which selects a path among paths where entropy encoding is performed on a residual transform coefficient obtained by transforming and quantizing a residual block that is a difference between a current block and a predicted block;
an entropy encoding unit which encodes path information on the selected path; and
a decoding unit which decodes the encoded residual transform coefficient based on the path information.

49. The coding apparatus of claim 48,
wherein the path selection unit comprises a calculation unit which calculates a first RD (rate-distortion) cost of a first path where the entropy encoding is performed on the residual transform coefficient and calculates a second RD cost of a second path where a vector corresponding to the residual transform coefficient is generated and the entropy encoding is performed on an index matching a reference vector that is most similar to the vector among reference vectors of residual transform coefficients of a sampled picture, and
wherein the calculation unit compares the first RD cost with the second RD cost and selects the path having a smaller RD cost.

50. The coding apparatus of claim 49, wherein the decoding unit comprises:
an entropy decoding unit which extracts the path information and decodes the residual transform coefficient through the first path or an index through the second path according to the path indicated by the extracted path information;
an optimal vector inversely-searching unit which searches for a reference vector corresponding to the index from reference vectors that are stored in advance through the second path;
a residual transform coefficient generation unit which reconstructs a residual transform coefficient corresponding to the searched reference vector; and
an inverse-quantization inverse-transformation unit which performs inverse quantization and inverse transformation on the residual transform coefficient.

51. A computer-readable medium having embodied thereon a computer program for executing the method of any one of claims 1 to 26.
